(19) United States
(12) Patent Application Publication
(10) Pub. No.: US 2013/0233056 A1
(43) Pub. Date: Sep. 12, 2013

(54) METHOD FOR MEASURING SPECIFIC GRAVITY OF COMBUSTIBLE GASES, DEVICE FOR MEASURING SPECIFIC GRAVITY, AND DEVICE FOR MEASURING WOBBE INDEX

(71) Applicant: Tomoo Ishiguro, Tokyo (JP)

(72) Inventor: Tomoo Ishiguro, Tokyo (JP)

(73) Assignee: RIKEN KEIKI CO., LTD., Itabashi-ku, Tokyo (JP)

(21) Appl. No.: 13/885,383

(22) PCT Filed: Aug. 4, 2011
(86) PCT No.: PCT/JP2011/067874

§ 371 Date: May 14, 2013

(30) Foreign Application Priority Data
Nov. 15, 2010 (JP) 2010-254563
Nov. 15, 2010 (JP) 2010-254564

(51) Int. Cl. G01N 9/00

(52) U.S. Cl. CPC G01N 9/00
USPC 73/30.01

(57) ABSTRACT

A method for measuring specific gravity of a combustible gas includes measuring the refractive index and sound speed of a gas of interest which contains at least one type of gas selected from a hydrocarbon gas, hydrogen gas, and carbon monoxide gas, and computing the value of the specific gravity Da of the gas of interest from Equation (1) below using a value selected as a correction factor x from within a range of 2.4 to 9.3 on the basis of a refractive index converted specific gravity Dn determined from the refractive index and a sound speed converted specific gravity Ds determined from the sound speed:

Da=Ds−[(Ds−Dn)/(1−x)] Equation (1).

### TECHNICAL FIELD

The present invention relates to a method for measuring the specific gravity of a combustible gas, a device for measuring the specific gravity thereof, and a device for measuring the Wobbe index thereof.

### BACKGROUND ART

Conventionally, various types of techniques are known as a method for determining, for example, the heat quantity and the Wobbe index indicative of the combustion properties of a combustible gas such as a fuel gas which is mainly composed of a paraffin-based hydrocarbon gas.

For example, a simplified technique has been employed for determining the Wobbe index or a value which is obtained by dividing the heat quantity of a combustible gas, serving as a gas of interest, by the square root of the specific gravity thereof. In this method, the values of the specific gravity and the heat quantity of the gas of interest are individually determined using appropriate devices, and then the value of the Wobbe index is computed from the resulting values of the specific gravity and the heat quantity.

In such a technique, each device is required to be provided in a prescribed manner. Furthermore, the device employed to determine the value of the specific gravity is of batch type and requires the pressure of the gas to be reduced to the atmospheric level at the time of measurement. Thus, the measurement system requires a considerable length of time for intricate setup and manipulation, and additionally, cannot perform continual measurement operations. Furthermore, the technique has also the problem that there occurs a time lag between the values of the specific gravity and the heat quantity though it is critical that the values of the specific gravity and the heat quantity made available for computation of the Wobbe index should be measured at the same time.

To solve such a problem, a device for determining the Wobbe index has been suggested. This device is configured to measure the speed of sound waves propagating through a gas of interest, i.e., the sound speed of the gas of interest; determine the values of the specific gravity and the heat quantity of the gas of interest on the basis of the resulting value of the sound speed; and compute the value of the Wobbe index from the resulting values of the specific gravity and the heat quantity (for example, see Patent Literature 1 and Patent Literature 2).

With the device having such a configuration, the measurement system can be manipulated in a simplified manner allowing for performing continual measurements. Furthermore, the values of the specific gravity and the heat quantity can be obtained from one measured value, more specifically, from the value of the sound speed of the gas of interest. It is thus possible to prevent the occurrence of a time lag between the value of the specific gravity and the value of the heat quantity made available for computation of the Wobbe index. Furthermore, the specific gravity of a paraffin-based hydrocarbon gas has a correlation to the sound speed, so that the value of the specific gravity is determined with the help of the property that there is a correlation between the specific gravity and the sound speed of the paraffin-based hydrocarbon gas. Thus, in particular, for example, when the gas of interest is composed only of the paraffin-based hydrocarbon gas such as a town gas which is composed of a gas mixture of a liquefied natural gas (LNG) and a liquefied petroleum gas (LPG), the value of the Wobbe index can be obtained with high reliability.

However, when the gas of interest is, for example, a natural gas which has been just produced from a gas field, a coke oven gas, blast furnace gas, converter gas, coal mine gas, or biogas, such a device has the following problems.

A natural gas which has been just produced from a gas field, coke oven gas, blast furnace gas, converter gas, coal mine gas, or biogas contains not only a paraffin-based hydrocarbon gas but also a number of gases other than the paraffin-based hydrocarbon gas. The gases other than the paraffin-based hydrocarbon gas include a gas, such as a carbon dioxide gas, carbon monoxide gas, nitrogen gas, and oxygen gas, which does not have the same properties as those of the paraffin-based hydrocarbon gas between the specific gravity and the sound speed. Thus, since a gas which does not have the same properties as those of such a paraffin-based hydrocarbon gas is contained, there occurs a big difference between the value of the specific gravity determined on the basis of the sound speed and the true value of the specific gravity of the gas of interest. Thus, this would also inevitably cause a big difference to occur between the value of the Wobbe index determined from the value of the specific gravity and the true value of the Wobbe index of the gas of interest.

Furthermore, for example, when the mixture ratio of multiple types of gases being contained is changed due to environmental conditions or the like, the change would not be accommodated.

### CITATION LIST

### Patent Literature

Patent Literature 1: Japanese Patent Application Laid-Open No. 2000-39425
Patent Literature 2: Japanese Patent Application Laid-Open No. 2000-39426

### SUMMARY OF INVENTION

### Technical Problem

The present invention has been made on the basis of the foregoing circumstances and has as its object the provision of a method for measuring the specific gravity of a combustible gas and a device for measuring the specific gravity thereof, the combustible gas containing at least one type of gas selected from a hydrocarbon gas, hydrogen gas, and carbon monoxide gas, the method and the device being capable of measuring the specific gravity of the combustible gas with high reliability regardless of the composition thereof.

The present invention has as another object the provision of a device for measuring the Wobbe index of a combustible gas, the combustible gas containing at least one type of gas selected from a hydrocarbon gas, hydrogen gas, and carbon monoxide gas, the device being capable of measuring the Wobbe index of the combustible gas with high reliability regardless of the composition thereof and obtaining the value a Wobbe index in a short time.

### Solution to Problem

The present invention provides a method for measuring the specific gravity of a combustible gas which contains at least one type of gas selected from a hydrocarbon gas, hydrogen gas, and carbon monoxide gas.

The method is characterized by measuring the refractive index of a gas of interest; measuring the sound speed of the gas of interest; and computing the value of a specific gravity Da of the gas of interest from Equation (1) below using a value selected as a correction factor x from within a range of 2.4 to 9.3 on the basis of a refractive index converted specific gravity Dn determined from the value of the refractive index and a sound speed converted specific gravity Ds determined from the value of the sound speed.

Da=Ds−[(Ds−Dn)/(1−x)] Equation (1)

In the method for measuring the specific gravity of a combustible gas according to the present invention, the value of the correction factor x is preferably 4.9 to 6.2 in Equation (1) above.

In the method for measuring the specific gravity of a combustible gas according to the present invention, the gas of interest preferably contains at least one type of a carbon dioxide gas, nitrogen gas, and oxygen gas.

In the method for measuring the specific gravity of a combustible gas according to the present invention, the gas of interest is preferably any of a natural gas, coke oven gas, blast furnace gas, converter gas, coal mine gas, and biogas.

A device for measuring the specific gravity of a combustible gas according to the present invention is configured to measure the specific gravity of a combustible gas which contains at least one type of gas selected from a hydrocarbon gas, hydrogen gas, and carbon monoxide gas.

The device for measuring the specific gravity of a combustible gas is characterized by including: a refractive index converted specific gravity measuring mechanism for determining a refractive index converted specific gravity Dn from the value of the refractive index of a gas of interest; a sound speed converted specific gravity measuring mechanism for determining a sound speed converted specific gravity Ds from the value of the sound speed of the gas of interest; and a specific gravity calculating mechanism, the mechanism computing the value of a specific gravity Da of the gas of interest from Equation (1) below using a value selected as a correction factor x from within a range of 2.4 to 9.3 on the basis of the refractive index converted specific gravity Dn obtained in the refractive index converted specific gravity measuring mechanism and the sound speed converted specific gravity Ds obtained in the sound speed converted specific gravity measuring mechanism.

A device for measuring the Wobbe index of a combustible gas according to the present invention is configured to measure the Wobbe index of a combustible gas which contains at least one type of gas selected from a hydrocarbon gas, hydrogen gas, and carbon monoxide gas.

The device for measuring the Wobbe index of a combustible gas includes: a specific gravity measuring mechanism for measuring the specific gravity of a gas of interest; a heat quantity measuring mechanism for measuring the heat quantity of the gas of interest; and a Wobbe index calculating mechanism for computing the value of a Wobbe index on the basis of the value of the specific gravity measured by the specific gravity measuring mechanism and the value of the heat quantity measured by the heat quantity measuring mechanism, the mechanisms being installed within a common housing.

The device is characterized in that the specific gravity measuring mechanism computes the value of the specific gravity Da of the gas of interest on the basis of a refractive index converted specific gravity Dn determined from the value of the refractive index of the gas of interest and a sound speed converted specific gravity Ds determined from the value of the sound speed of the gas of interest from Equation (1) below using a value selected as a correction factor x from within a range of 2.4 to 9.3.

In the device for measuring the Wobbe index of a combustible gas according to the present invention, the value of the correction factor x is preferably 4.9 to 6.2 in Equation (1) above.

In the device for measuring the Wobbe index of a combustible gas according to the present invention, the specific gravity measuring mechanism includes refractive index measurement means for measuring the refractive index of the gas of interest and sound speed measurement means for measuring the sound speed of the gas of interest.

The refractive index measurement means and the sound speed measurement means are preferably supplied with the gas of interest drawn in through a common gas inlet provided in the housing.

In the device for measuring the Wobbe index of a combustible gas according to the present invention, the gas of interest preferably contains at least one type of a carbon dioxide gas, nitrogen gas, and oxygen gas.

In the device for measuring the Wobbe index of combustible gas according to the present invention, the gas of interest is preferably any of a natural gas, coke oven gas, blast furnace gas, converter gas, coal mine gas, and biogas.

### Advantageous Effects of Invention

In the method for measuring the specific gravity of a combustible gas according to the present invention, the value of the specific gravity Da of a gas of interest is computed from a particular arithmetic equation using a value within a particular range as a correction factor x on the basis of the refractive index converted specific gravity Dn and the sound speed converted specific gravity Ds of the gas of interest. The gas of interest may contain a particular gas which has a particular correlation between the specific gravity and the refractive index as well as a particular correlation and between the specific gravity and the sound speed as well as a mixed gas which does not have the same properties as those of the particular gas between the specific gravity and the sound speed and between the specific gravity and the refractive index. Or only the mixed gas may be contained. Even in these cases, the difference occurring between the refractive index converted specific gravity Dn and the true value of the specific gravity of the gas of interest and the difference occurring between the sound speed converted specific gravity Ds and the true value of the specific gravity of the gas of interest, the differences being caused by the mixed gas contained, are appropriately corrected on the basis of the relation between the differences between these two values and the true values thereof. As a result, the difference between the resulting value of the specific gravity Da of the gas of interest and the true value of the specific gravity of the gas of interest is reduced irrespective of the composition of the gas of interest.

Thus, in the method for measuring the specific gravity of a combustible gas according to the present invention, it is possible to measure the specific gravity of a combustible gas, with high reliability regardless of the composition thereof, the combustible gas containing at least one type of gas selected from a hydrocarbon gas, hydrogen gas, and carbon monoxide gas.

In the device for measuring the specific gravity of a combustible gas according to the present invention, the specific gravity calculating mechanism computes the value of the specific gravity Da of the gas of interest from a particular arithmetic equation using a value within a particular range as a correction factor x on the basis of the refractive index converted specific gravity Dn obtained in the refractive index converted specific gravity measuring mechanism and the sound speed converted specific gravity Ds obtained in the sound speed converted specific gravity measuring mechanism. It is thus possible to perform continual measurements. Furthermore, the gas of interest may contain a particular gas which has a particular correlation between the specific gravity and the refractive index as well as a particular correlation and between the specific gravity and the sound speed as well as a mixed gas which does not have the same properties as those of the particular gas between the specific gravity and the sound speed and between the specific gravity and the refractive index. Or only the mixed gas may be contained. Even in these cases, the difference occurring between the refractive index converted specific gravity Dn and the true value of the specific gravity of the gas of interest and the difference occurring between the sound speed converted specific gravity Ds and the true value of the specific gravity of the gas of interest, the differences being caused by the mixed gas contained, are appropriately corrected on the basis of the relation between the differences between these two values and the true values thereof. As a result, the difference between the resulting value of the specific gravity Da of the gas of interest and the true value of the specific gravity of the gas of interest is reduced irrespective of the composition of the gas of interest.

Thus, according to the device for measuring the specific gravity of a combustible gas according to the present invention, it is possible to continually measure the specific gravity of a combustible gas, with high reliability regardless of the composition thereof, the combustible gas containing at least one type of gas selected from a hydrocarbon gas, hydrogen gas, and carbon monoxide gas.

In the device for measuring the Wobbe index of a combustible gas according to the present invention, the specific gravity measuring mechanism, the heat quantity measuring mechanism, and the Wobbe index calculating mechanism are provided within a common housing in a prescribed manner. Thus, at the time of measurement, the measurement system can be set up and manipulated in a simplified manner without requiring a considerable length of time, also allowing for performing continual measurements. In addition, it is possible to prevent the occurrence of a time lag between the value of the heat quantity and the value of the specific gravity which are made available for computation of the Wobbe index.

Furthermore, the specific gravity measuring mechanism is configured to compute the value of the specific gravity Da of the gas of interest from a particular arithmetic equation using a value within a particular range as a correction factor x on the basis of the refractive index converted specific gravity Dn and the sound speed converted specific gravity Ds. The gas of interest may contain a particular gas which has a particular correlation between the specific gravity and the refractive index as well as a particular correlation and between the specific gravity and the sound speed as well as a mixed gas which does not have the same properties as those of the particular gas between the specific gravity and the sound speed and between the specific gravity and the refractive index. Or only the mixed gas may be contained. Even in these cases, the difference occurring between the refractive index converted specific gravity Dn and the true value of the specific gravity of the gas of interest and the difference occurring between the sound speed converted specific gravity Ds and the true value of the specific gravity of the gas of interest, the differences being caused by the mixed gas contained, are appropriately corrected on the basis of the relation between the differences between these two values and the true values thereof. As a result, the difference between the value of the specific gravity Da of the gas of interest used to determine the Wobbe index in the Wobbe index calculating mechanism and the true value of the specific gravity of the gas of interest is reduced irrespective of the composition of the gas of interest.

Thus, in the device for measuring the Wobbe index of a combustible gas according to the present invention, it is possible to continually measure the Wobbe index of a combustible gas, with high reliability regardless of the composition thereof, the combustible gas containing at least one type of gas selected from a hydrocarbon gas, hydrogen gas, and carbon monoxide gas, and can obtain the value of the Wobbe index in a short time.

### BRIEF DESCRIPTION OF DRAWINGS

FIG. 1 is an explanatory view illustrating an example of the configuration of a device for measuring the specific gravity of a combustible gas according to the present invention.

FIG. 2 is an explanatory view illustrating an example of the configuration of an ultrasonic gas densimeter used as a sound speed converted specific gravity measuring mechanism, the mechanism constituting the device of FIG. 1 for measuring the specific gravity of a combustible gas.

FIG. 3 is an explanatory view illustrating another example of the configuration of the ultrasonic gas densimeter used as a sound speed converted specific gravity measuring mechanism, the mechanism constituting the device of FIG. 1 for measuring the specific gravity of a combustible gas.

FIG. 4 is an explanatory view illustrating an example of the configuration of a refractive index densimeter used as a refractive index converted specific gravity measuring mechanism, the mechanism constituting the device of FIG. 1 for measuring the specific gravity of a combustible gas.

FIG. 5 is an explanatory view illustrating an example of the configuration of a device for measuring the Wobbe index of a combustible gas according to the present invention.

FIG. 6 is an explanatory view illustrating, an example of the configuration of a specific gravity measuring mechanism, the mechanism constituting the device of FIG. 5 for measuring the Wobbe index of a combustible gas.

FIG. 7 is an explanatory view illustrating an example of the configuration of a heat quantity measuring mechanism, which constitutes a device for measuring the Wobbe index of a combustible gas according to the present invention, in conjunction with an example of the configuration of the device for measuring a Wobbe index.

FIG. 8 is an explanatory view illustrating another example of the configuration of a heat quantity measuring mechanism, which constitutes a device for measuring the Wobbe index of a combustible gas according to the present invention, in conjunction with an example of the configuration of the device for measuring a Wobbe index.

FIG. 9 is an explanatory view illustrating the outline of a specific gravity measurement system employed in Experimental Example 2.

FIG. 10 is a graph showing the differences, obtained for a sample gas in Experimental Example 2, between the true value and the refractive index converted specific gravity Dn, the sound speed converted specific gravity Ds, and the specific gravity Da which is obtained from Equation (1) on the basis of the refractive index converted specific gravity Dn and the sound speed converted specific gravity Ds.

### DESCRIPTION OF EMBODIMENTS

Now, the embodiments of the present invention will be described in more detail below.

<Specific Gravity Measuring Device and Specific Gravity Measuring Method>

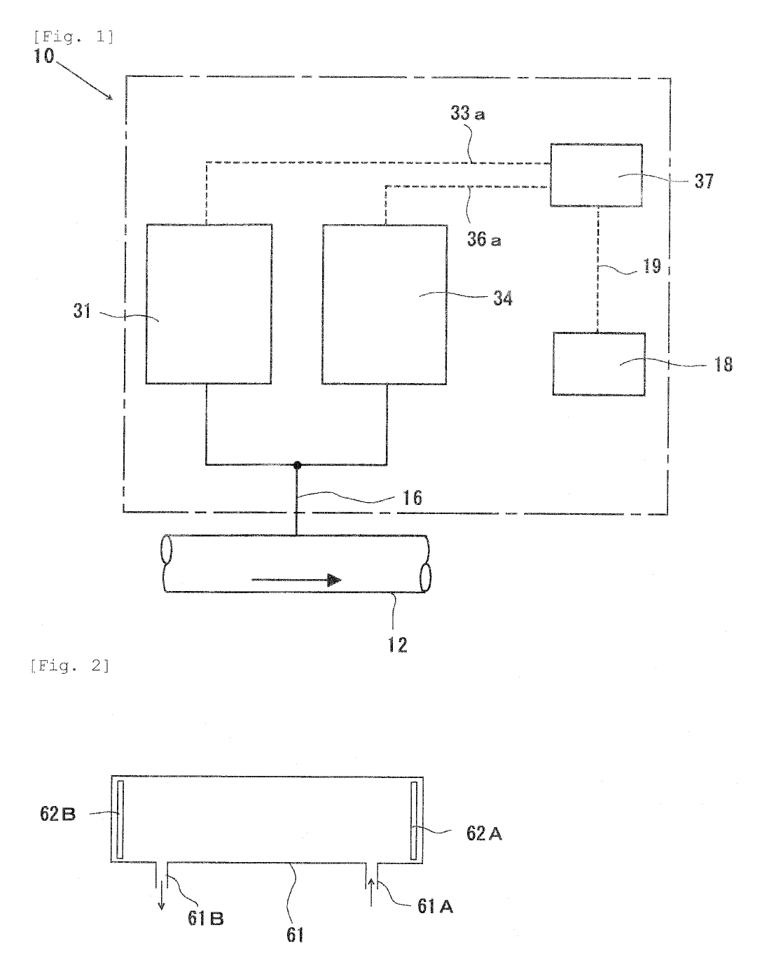

FIG. 1 is an explanatory view illustrating an example of the configuration of a device for measuring the specific gravity of a combustible gas according to the present invention.

The specific gravity measuring device 10 employs, as a gas of interest, a combustible gas which contains at least one type of flammable gas selected from a hydrocarbon gas, hydrogen gas, and carbon monoxide gas, and is used, for example, to measure the specific gravity of a gas flowing in the direction shown by the arrow of FIG. 1 through a gas pipeline 12.

Here, in the device for measuring the specific gravity of a combustible gas and the method for measuring the specific gravity thereof according to the present invention, the combustible gas constituting the gas of interest may be composed of a gas (hereafter also referred to as a “particular gas”), for example, like a paraffin-based hydrocarbon gas or a type of hydrocarbon gas, which has a particular correlation between the specific gravity and the refractive index as well as a particular correlation and between the specific gravity and the sound speed. The gas of interest may also be composed of a gas mixture of a particular gas and a mixed gas which does not have the same properties as those of the particular gas between the specific gravity and the sound speed and between the specific gravity and the refractive index. The gas of interest may also be composed of a mixed ags.

The specific gravity measuring device 10 includes a refractive index converted specific gravity measuring mechanism 31 for obtaining the refractive index converted specific gravity Dn determined from the value of the refractive index of a gas of interest and a sound speed converted specific gravity measuring mechanism 34 for obtaining the sound speed converted specific gravity Ds determined from the value of the sound speed of the gas of interest. Also included is a specific gravity calculating mechanism 37 for computing the value of the specific gravity Da of the gas of interest on the basis of the refractive index converted specific gravity Dn obtained in the refractive index converted specific gravity measuring mechanism 31 and the sound speed converted specific gravity Ds obtained in the sound speed converted specific gravity measuring mechanism 34.

Concerning the value of the specific gravity Da of the gas of interest calculated in the specific gravity calculating mechanism 37, the data of the value of the specific gravity Da is transmitted to a display unit (hereafter also referred to as the “specific gravity display unit”) 18 through a data transmission path 19. On the specific gravity display unit 18, the value of the specific gravity Da of the gas of interest is displayed.

In FIG. 1, shown is a gas flow path 16 which has a branch structure for supplying a gas flowing through the gas pipeline 12 as a gas of interest to each of the refractive index converted specific gravity measuring mechanism 31 and the sound speed converted specific gravity measuring mechanism 34. Also shown is a data transmission path 33a which serves to transmit the data of the refractive index converted specific gravity Dn obtained in the refractive index converted specific gravity measuring mechanism 31 to the specific gravity calculating mechanism 37. Further shown is a data transmission path 36a which serves to transmit the data of the sound speed converted specific gravity Ds obtained in the sound speed converted specific gravity measuring mechanism 34 to the specific gravity calculating mechanism 37.

In the specific gravity measuring device 10 having such a configuration, the specific gravity calculating mechanism 37 computes the value of the specific gravity Da of the gas of interest by following the method for measuring the specific gravity of a combustible gas according to the present invention (hereafter also referred to as the “particular method for measuring a specific gravity”).

More specifically, according to the particular method for measuring a specific gravity, the value of the specific gravity Da of the gas of interest is computed from Equation (1) above on the basis of the refractive index converted specific gravity Dn and the sound speed converted specific gravity Ds under the condition of using a value selected as a correction factor x from within a range of 2.4 to 9.3.

Here, the value of the specific gravity Da of the gas of interest to be computed, and the refractive index converted specific gravity Dn and the sound speed converted specific gravity Ds to be made available for use in computing the value of the specific gravity Da are determined with the value for air being unity.

In Equation (1), the correction factor x is not lower than 2.4 and not greater than 9.3, but preferably 4.9 to 6.2 in particular.

Even when the gas of interest contains a mixed gas, using a value within the aforementioned range as the correction factor x allows the resulting value of the specific gravity Da of the gas of interest to have a reduced difference from the true value of the specific gravity of the gas of interest irrespective of the composition of the mixed gas and the composition of the gas of interest, that is, to be approximated to the true value of the specific gravity of the gas of interest.

As can be seen clearly from Experimental Example 1 to be discussed later, this is because the value of the correction factor x is defined on the basis of the differences occurring between the true value of the specific gravity of the gas of interest and the refractive index converted specific gravity Dn and the sound speed converted specific gravity Ds, the differences being caused by a mixed gas being contained in the gas of interest. Furthermore, the ratio between the differences between the true value of the specific gravity of the gas of interest and the refractive index converted specific gravity Dn and the sound speed converted specific gravity Ds has a particular relation irrespective of the composition of the mixed gas. Thus, even if the mixed gas has any composition, it is possible to appropriately correct, on the basis of this relation, the differences occurring between the true value of the specific gravity of the gas of interest and the refractive index converted specific gravity Dn and the sound speed converted specific gravity Ds.

An excessively small correction factor x would not allow the differences occurring between the true value of the specific gravity of the gas of interest and the refractive index converted specific gravity Dn and the sound speed converted specific gravity Ds to be sufficiently corrected. This would cause a big difference to occur between the true value of the specific gravity of the gas of interest and the resulting values. On the other hand, an excessively large correction factor x would not allow the differences occurring between the true value of the specific gravity of the gas of interest and the refractive index converted specific gravity Dn and the sound speed converted specific gravity Ds to be appropriately corrected but to be excessively corrected. This would cause a big difference to occur between the true value of the specific gravity of the gas of interest and the resulting values.

As the specific gravity calculating mechanism 37, it is possible to use, for example, a personal computer or a recorder with an arithmetic function.

The sound speed converted specific gravity measuring mechanism 34 to obtain the sound speed converted specific gravity Ds may be configured to measure the speed of sound waves propagating through the gas of interest (the sound speed of the gas of interest), for example, by sound speed measurement means. Then, on the basis of the resulting value of the sound speed, sound speed to specific gravity converting means may be used to determine the value of the specific gravity (the sound speed converted specific gravity Ds). To this end, for example, utilizing the correlation between the sound speed and the specific gravity of a particular gas (more specifically, for example, a paraffin-based hydrocarbon gas), the correlation having been obtained in advance, for example, by drawing a graph, and assuming that the resulting value of the sound speed is the sound speed of the particular gas, that is, assuming that the value of the sound speed is that of the gas of interest containing only the particular gas, a reference can be made to the correlation.

Specific examples of the sound speed converted specific gravity measuring mechanism 34 may include, for example, a well-known ultrasonic gas densimeter.

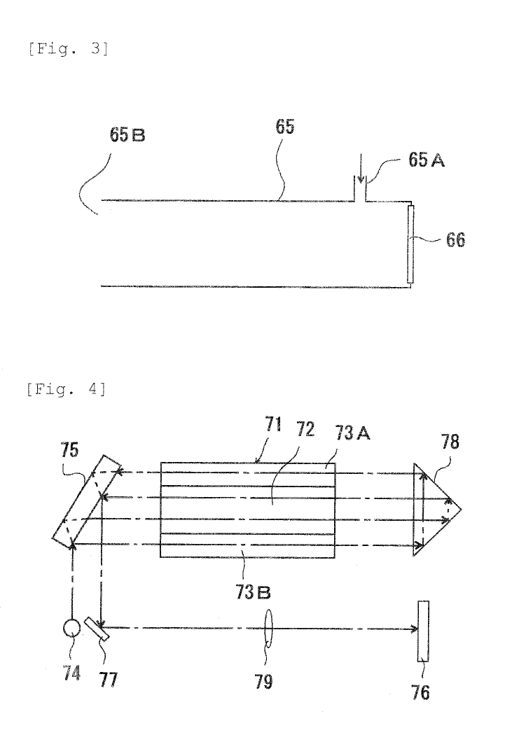

Here, the ultrasonic gas densimeter may be configured to include a pair of an ultrasound emitter element 62A and an ultrasound receiver element 623 as shown in FIG. 2 so as to determine the value of the specific gravity with the help of the time for ultrasounds to propagate between the pair of elements, or to include a piezoelectric element 66 as shown in FIG. 3 so as to determine the value of the specific gravity with the help of the resonance frequency of the ultrasound.

The ultrasonic gas densimeter of FIG. 2 includes: a measurement pipe 61 which serves as the sound speed measurement means and allows a gas of interest to flow therethrough, the measurement pipe 61 having a gas inlet 61A on one end and a gas outlet 61B on the other end; the ultrasound emitter element 62A provided on one end of the measurement pipe 61; and the ultrasound receiver element 62B provided on the other end of the measurement pipe 61. With the gas of interest flowing through the measurement pipe 61, the Ultrasonic gas densimeter measures the time (propagation time) required for an ultrasound emitted from the ultrasound emitter element 62A to propagate therethrough and reach the ultrasound receiver element 62B. Then, on the basis of the resulting value of the sound speed determined from the value of the propagation time, the sound speed converted specific gravity Ds of the gas of interest is obtained. In FIG. 2, the arrows show the direction of flow of the gas of interest.

On the other hand, the ultrasonic gas densimeter of FIG. 3 includes: a measurement pipe 65 which serves as the sound speed measurement means and allows a gas of interest to flow therethrough, the measurement pipe 65 having an opening at one end, the opening serving as a gas outlet 65B, and a gas inlet 65A at the other end; and the piezoelectric element 66 provided on the other end of the measurement pipe 65. With the gas of interest flowing through the measurement pipe 65, the ultrasonic gas densimeter allows the piezoelectric element 66 to emit and propagate an ultrasound through the measurement pipe 65, thereby measuring the resonance frequency of the ultrasound. Then, on the basis of the resulting value of the sound speed determined from the value of the resonance frequency, the sound speed converted specific gravity Ds of the gas of interest is obtained. In FIG. 3, the arrow shows the direction of flow of the gas of interest.

The refractive index converted specific gravity measuring mechanism 31 to obtain the refractive index converted specific gravity Dn may be configured to measure the refractive index of the gas of interest, for example, by refractive index measurement means. Then, on the basis of the resulting value of the refractive index, refractive index to specific gravity converting means may be used to determine the value of the specific gravity (the refractive index converted specific gravity Dn). To this end, utilizing the correlation between the refractive index and the specific gravity of a particular gas (more specifically, for example, a paraffin-based hydrocarbon gas) which has been obtained in advance, for example, by drawing a graph, and assuming that the resulting value of the refractive index is the refractive index of the particular gas, that is, assuming that the value of the refractive index is that of the gas of interest containing only the particular gas, a reference can be made to the correlation.

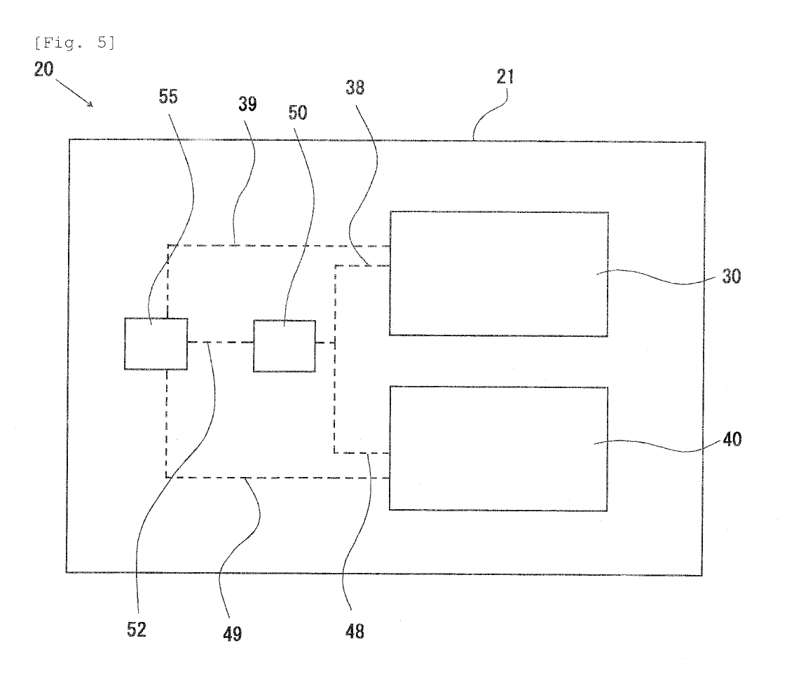

A specific example of the refractive index converted specific gravity measuring mechanism 31 may include, for example as shown in FIG. 4, a refractive index densimeter. This refractive index densimeter is configured to detect, as the displacement of interference fringes, the difference in the refractive index of light between the gas of interest and a standard gas such as air, and then obtain the refractive index converted specific gravity Dn of the gas of interest on the basis of the displacement of interference fringes.

The refractive index type densimeter of FIG. 4 serving as the refractive index measurement means, includes: a chamber 71 which is made up of a gas-of-interest cell 72 for drawing in a gas of interest and standard-gas cells 73A and 73B for drawing in a standard gas such as air, the cells 72, 73A, and 73B being partitioned in the chamber 71; a parallel plane mirror 75 for splitting a beam of light from a light source 74; a prism 78 which is adjusted and arranged so that the beams of light having been split by the parallel plane mirror 75 and passed through the chamber 71 are reflected and thereby changed in the direction of travel so as to pass through the chamber 71 again and then be superimposed on the parallel plane mirror 75 to yield interference fringes; and the interference fringe detection means 76 for receiving combined beams of light (interfered light) which have been superimposed on the parallel plane mirror 75.

FIG. 4 shows a plane mirror 77 for reflecting combined beams of light; a condenser lens 79 for condensing combined beams of light; and the interference fringe detection means 76 which is disposed at the focal position of the condenser lens 79. On the other hand, the alternate long and short dashed line arrows show the path through which light from the light source 74 travels until the light is received by the interference fringe detection means 76.

During a measurement operation, in the specific gravity measuring device 10 having such a configuration, a gas flowing through the gas pipeline 12 via the gas flow path 16 is supplied as the gas of interest to each of the refractive index converted specific gravity measuring mechanism 31 and the sound speed converted specific gravity measuring mechanism 34, thereby allowing the refractive index converted specific gravity Dn to be determined in the refractive index converted specific gravity measuring mechanism 31 and the sound speed converted specific gravity Ds to be determined in the sound speed converted specific gravity measuring mechanism 34. In this manner, the data of the refractive index converted specific gravity Dn obtained in the refractive index converted specific gravity measuring mechanism 31 is transmitted to the specific gravity calculating mechanism 37 via the data transmission path 33a, while the data of the sound speed converted specific gravity Ds obtained in the sound speed converted specific gravity measuring mechanism 34 is transmitted to the specific gravity calculating mechanism 37 via the data transmission path 36a. Then, the specific gravity calculating mechanism 37 computes the value of the specific gravity Da on the basis of the refractive index converted specific gravity Dn and the sound speed converted specific gravity Ds from Equation (1) above using a value selected as the correction factor x from within a particular range. The value of the specific gravity Da obtained in this manner is transmitted to the specific gravity display unit 18 via the data transmission path 19, and then displayed on the specific gravity display unit 18.

The specific gravity measuring device 10 described above employs, as the gas of interest, a combustible gas which is one type of flammable gas of a hydrocarbon gas, hydrogen gas, and carbon monoxide gas or two or more types of flammable gas of those flammable gases in combination. However, a combustible gas constituting the gas of interest may contain, as another component, at least one type of a carbon dioxide gas, nitrogen gas, and oxygen gas in the form of a mixed gas.

Specific examples of the gas of interest may include, for example, a natural gas, coke oven gas, blast furnace gas, converter gas, coal mine gas, and biogas. These gases contain a mixed gas such as a carbon monoxide gas, carbon dioxide gas, nitrogen gas, and oxygen gas in conjunction with a particular gas such as a paraffin-based hydrocarbon gas and a hydrogen gas.

Thus, the specific gravity measuring device 10 is configured to allow the specific gravity calculating mechanism 37 to follow a particular method for measuring a specific gravity so as to compute the value of the specific gravity Da of the gas of interest on the basis of the refractive index converted specific gravity Dn obtained by the refractive index converted specific gravity measuring mechanism 31 and the sound speed converted specific gravity Ds obtained by the sound speed converted specific gravity measuring mechanism 34. Thus, continual measurements can be performed. On the other hand, the gas of interest may contain a mixed gas, which does not have the same properties as those of a particular gas, in conjunction with the particular gas, or the gas of interest may contain only the mixed gas. Even in these cases, the differences, caused by the mixed gas being contained, between the true value of the specific gravity of the gas of interest and the refractive index converted specific gravity Dn and the sound speed converted specific gravity Ds, which are obtained respectively in the refractive index converted specific gravity measuring mechanism 31 and the sound speed converted specific gravity measuring mechanism 34, are corrected with the help of the relation between the differences occurring between the true value of the specific gravity of the gas of interest and the refractive index converted specific gravity Dn and the sound speed converted specific gravity Ds. Furthermore, in this particular method for measuring a specific gravity, using a numerical value within a particular range as the correction factor x allows the device to make an appropriate correction even when any numerical value is selected from within the particular range, irrespective of the composition of the mixed gas and the composition of the gas of interest. Thus, the resulting value of the specific gravity Da of the gas of interest has a reduced difference from the true value of the specific gravity of the gas of interest irrespective of the composition of the gas of interest, that is, is approximated to the true value of the specific gravity of the gas of interest.

Thus, according to the specific gravity measuring device 10, it is possible to obtain the specific gravity Da of the gas of interest which has a reduced difference from the true value of the specific gravity of the gas of interest irrespective of the composition of the gas of interest. Thus, the specific gravity of the gas of interest can be measured with high reliability even when the gas of interest is a gas which contains a particular gas and a mixed gas at an unknown ratio, or more specifically, a natural gas which has been just produced from a gas field, coke oven gas, blast furnace gas, converter gas, coal mine gas, and biogas.

Furthermore, the specific gravity measuring device 10 is capable of measuring the specific gravity of the gas of interest with high reliability even when the gas of interest is composed of a particular gas (more specifically, a paraffin-based hydrocarbon gas) such as a town gas which contains a gas mixture of, for example, an LNG and an LPG or even when the gas of interest is composed only of a mixed gas (for example, composed of a gas mixture of a carbon monoxide gas and another mixed gas.)

Furthermore, according to the specific gravity measuring device 10, the resulting value of the specific gravity Da has a reduced difference from the true value of the specific gravity of the gas of interest irrespective of the composition of the gas of interest. Thus, for example, even when environment conditions or various situations such as changes of supplied gases flowing through the gas pipeline 12 have caused significant variations in the type and concentration of a mixed gas in the gas of interest, these variations can be accommodated.

Furthermore, in the specific gravity measuring device 10 allows the specific gravity calculating mechanism 37 to determine the value of the specific gravity Da of the gas of interest by the particular method for measuring a specific gravity. More specifically, the refractive index converted specific gravity measuring mechanism 31 measures the refractive index of the gas of interest and can easily obtain the refractive index converted specific gravity Dn from the value of the refractive index by utilizing the correlation between the refractive index and the specific gravity of the particular gas. On the other hand, the sound speed converted specific gravity measuring mechanism 34 measures the sound speed of the gas of interest and can easily obtain the sound speed converted specific gravity Ds from the value of the sound speed by utilizing the correlation between the sound speed and the specific gravity of the particular gas. In addition, the specific gravity calculating mechanism 37 can also easily provide the value of the specific gravity Da only by calculating Equation (1) above. It is thus possible to measure the specific gravity of the gas of interest very easily with high reliability.

As such, the device for measuring the specific gravity of a combustible gas according to the present invention and the method for measuring the specific gravity of a combustible gas according to the present invention are capable of measuring the specific gravity of the gas of interest with high reliability regardless of the composition thereof. Thus, the device and the method are preferredly employed, for example, as means for measuring the specific gravity of a gas of interest in a system for measuring physical property values such as the Wobbe index of the gas of interest which is computed using the value of the specific gravity.

<Device for Measuring a Wobbe Index>

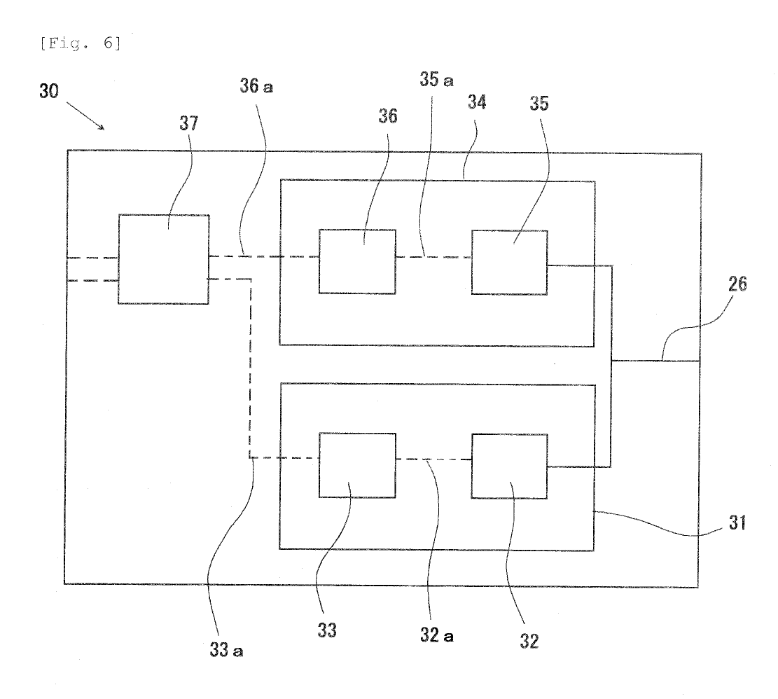

FIG. 5 is an explanatory view illustrating an example of the configuration of the device for measuring the Wobbe index of a combustible gas according to the present invention.

The Wobbe index measuring device 20 employs, as a gas of interest, a combustible gas which contains at least one type of flammable gas selected from a hydrocarbon gas, hydrogen gas, and carbon monoxide gas.

Here, in the device for measuring the Wobbe index of a combustible gas according to the present invention, the combustible gas constituting the gas of interest may be composed of a particular gas, for example, like a paraffin-based hydrocarbon gas or a type of hydrocarbon gas, which has particular correlations between the specific gravity and the refractive index as well as particular correlation and between the specific gravity and the sound speed. The gas of interest may also be composed of a gas mixture of the particular gas and a mixed gas which does not have the same properties as those of the particular gas between the specific gravity and the sound speed and between the specific gravity and the refractive index. The gas of interest may also be composed of a mixed gas.

The Wobbe index measuring device 20 includes: specific gravity measuring mechanism 30 for measuring the specific gravity of a gas of interest; a heat quantity measuring mechanism 40 for measuring the heat quantity of the gas of interest; and a Wobbe index calculating mechanism 50 which computes the value of the Wobbe index on the basis of the resulting value of the specific gravity measured by the specific gravity measuring mechanism 30 and the value of the heat quantity measured by the heat quantity measuring mechanism 40. The specific gravity measuring mechanism 30, the heat quantity measuring mechanism 40, and the Wobbe index calculating mechanism 50 are provided within a common housing 21 in a prescribed manner.

Concerning the value of the Wobbe index of the gas of interest calculated in the Wobbe index calculating mechanism 50, the data of the value of the Wobbe index is transmitted to a display unit 55 through a data transmission path 52 and then displayed on the display unit 55. Furthermore, in conjunction with the value of the Wobbe index of the gas of interest, the display unit 55 displays the value of the specific gravity of the gas of interest obtained in the specific gravity measuring mechanism 30 and the value of the heat quantity of the gas of interest obtained in the heat quantity measuring mechanism 40.

FIG. 5 shows: a data transmission path 38 for transmitting therethrough the data of the value of the specific gravity obtained in the specific gravity measuring mechanism 30 to the Wobbe index calculating mechanism 50; a data transmission path 39 for transmitting therethrough the data of the value of the specific gravity obtained in the specific gravity measuring mechanism 30 to the display unit 55; a data transmission path 48 for transmitting therethrough the data of the value of the heat quantity obtained in the heat quantity measuring mechanism 40 to the Wobbe index calculating mechanism 50; and a data transmission path 49 for transmitting therethrough the data of the value of the heat quantity obtained in the heat quantity measuring mechanism 40 to the display unit 55.

(Specific Gravity Measuring Mechanism)

The specific gravity measuring mechanism 30, as used herein, is capable of measuring the specific gravity of a gas of interest by the particular method for measuring a specific gravity.

A specific example of the specific gravity measuring mechanism 30 may include a device mentioned below, that is, the device for measuring the specific gravity of a combustible gas according to the present invention (hereafter also referred to as the “particular specific gravity measuring device”). As shown in FIG. 6, the device includes: the refractive index converted specific gravity measuring mechanism 31 to obtain the refractive index converted specific gravity Dn determined from the value of the refractive index of the gas of interest; the sound speed converted specific gravity measuring mechanism 34 to obtain the sound speed converted specific gravity Ds determined from the value of the sound speed of the gas of interest; and the specific gravity calculating mechanism 37 for computing the value of the specific gravity Da of the gas of interest on the basis of the refractive index converted specific gravity Dn and the sound speed converted specific gravity Ds by following the particular method for measuring a specific gravity.

FIG. 6 shows a gas flow path 26 having a branch structure for supplying the gas of interest, which has been drawn into a housing 21, through a gas inlet formed in the housing 21 to each of the refractive index converted specific gravity measuring mechanism 31 and the sound speed converted specific gravity measuring mechanism 34. Also shown are the data transmission path 33a for transmitting the data of the refractive index converted specific gravity Dn obtained in the refractive index converted specific gravity measuring mechanism 31 to the specific gravity calculating mechanism 37, and the data transmission path 36a for transmitting the data of the sound speed converted specific gravity Ds obtained in the sound speed converted specific gravity measuring mechanism 34 to the specific gravity calculating mechanism 37.

In the example in this figure, the sound speed converted specific gravity measuring mechanism 34 may be, for example, the ultrasonic gas densimeter as shown in FIG. 2 or FIG. 3, allowing the sound speed measurement means 35 to measure the speed of sound waves propagating through a gas of interest (the sound speed of the gas of interest). Then, on the basis of the resulting value of the sound speed, the sound speed to specific gravity converting means 36 may be used to determine the value of the specific gravity (the sound speed converted specific gravity Ds). To this end, the correlation between the sound speed and the specific gravity of a particular gas (more specifically, for example, a paraffin-based hydrocarbon gas) which has been obtained in advance, for example, by drawing a graph may be utilized, and assuming that the resulting value of the sound speed is the sound speed of the particular gas, a reference is made to the correlation. FIG. 6 shows a data transmission path 35a for transmitting the data of the value of the sound speed obtained in the sound speed measurement means 35 to the sound speed to specific gravity converting means 36.

On the other hand, the refractive index converted specific gravity measuring mechanism 31 may be, for example, the refractive index type densimeter as shown in FIG. 4, allowing the refractive index measurement means 32 to measure the refractive index of a gas of interest. Then, on the basis of the resulting value of the refractive index, refractive index to specific gravity converting means 33 may be used to determine the value of the specific gravity (the refractive index converted specific gravity Dn). To this end, utilizing the correlation between the refractive index and the specific gravity of a particular gas (more specifically, for example, paraffin-based hydrocarbon gas) which has been obtained in advance, for example, by drawing a graph, and assuming that the value of the resulting refractive index is the refractive index of the particular gas, a reference can be made to the correlation. FIG. 6 shows a data transmission path 32a for transmitting the data of the value of the refractive index obtained in the refractive index measurement means 32 to the refractive index to specific gravity converting means 33.

Furthermore, as a specific gravity calculating mechanism 37, it is possible to use, for example, a personal computer or a recorder with an arithmetic function.

In the specific gravity measuring mechanism 30 having such a configuration, the gas of interest is supplied to each of the refractive index converted specific gravity measuring mechanism 31 and the sound speed converted specific gravity measuring mechanism 34, at the same time through a gas flow path 26 which is common to the refractive index converted specific gravity measuring mechanism 31 and the sound speed converted specific gravity measuring mechanism 34. The refractive index converted specific gravity measuring mechanism 31 allows the refractive index measurement means 32 to measure the refractive index, thereby determining the refractive index converted specific gravity Dn, while the sound speed converted specific gravity measuring mechanism 34 allows the sound speed measurement means 35 to measure the sound speed, thereby determining the sound speed converted specific gravity Ds. Then, the data of the refractive index converted specific gravity Dn obtained in the refractive index converted specific gravity measuring mechanism 31 is transmitted to the specific gravity calculating mechanism 37 via the data transmission path 33a, while the data of the sound speed converted specific gravity Ds obtained in the sound speed converted specific gravity measuring mechanism 34 is transmitted to the specific gravity calculating mechanism 37 via the data transmission path 36a. This allows the specific gravity calculating mechanism 37 to compute the value of the specific gravity Da from Equation (1) above using a value selected as the correction factor x on the basis of the refractive index converted specific gravity Dn and the sound speed converted specific gravity Ds.

(Heat Quantity Measuring Mechanism)

The heat quantity measuring mechanism 40 can be configured in various ways so long as it is capable of measuring the heat quantity of a gas of interest.

Specific examples of the heat quantity measuring mechanism 40 may include an apparatus which is configured to measure one of physical property values having a particular correlation with the heat quantity and then determine the value of the heat quantity (the converted heat quantity) on the basis of the measured value. An apparatus may be included which is configured to determine the value of the heat quantity (the computed heat quantity) by computation on the basis of two converted heat quantities. This apparatus may be one which is disclosed, for example, in Japanese Patent Application Laid-Open No. 2009-42216 or Japanese Patent Application Laid-Open No. 2010-175261. Among those like the one above, since a value obtained as the value of the heat quantity can have a reduced difference from the true value of the heat quantity of the gas of interest irrespective of the composition of the gas of interest, such an apparatus which is configured to determine the computed heat quantity on the basis of two converted heat Quantities is preferable.

Specific examples of an apparatus which is configured to measure one of physical property values having a particular correlation with the heat quantity and then determine the converted heat quantity on the basis of the measured value may include the devices listed in (1-1) to (1-3) below.

(1-1) A device which is configured to measure the refractive index of the gas of interest and then determine the value of the heat quantity (a refractive index converted heat quantity Qn) on the basis of the resulting value of the refractive index.

More specifically, the device may be configured to measure the refractive index of the gas of interest, for example, by the refractive index measurement means, and on the basis of the resulting value of the refractive index, allow refractive index to heat quantity converting means to determine the refractive index converted heat quantity Qn by utilizing the correlation between the refractive index and the heat quantity (for example, the correlation between the refractive index and the heat quantity of a paraffin-based hydrocarbon gas) which has been obtained in advance, for example, by drawing a graph.

(1-2) A device which is configured to measure the thermal conductivity of the gas of interest and then on the basis of the resulting value of the thermal conductivity, determine the value of the heat quantity (a thermal conductivity converted heat quantity Qt).

More specifically, the device may be configured to measure the thermal conductivity of the gas of interest, for example, by thermal conductivity measurement means, and on the basis of the resulting value of the thermal conductivity, thermal conductivity to heat quantity converting means is allowed to determine the thermal conductivity converted heat quantity Qt by utilizing the correlation between the thermal conductivity and the heat quantity (for example, the correlation between the thermal conductivity and the heat quantity of a paraffin-based hydrocarbon gas) which has been obtained in advance, for example, by drawing a graph.

(1-3) A device which is configured to measure the sound speed of the gas of interest and then on the basis of the resulting value of the sound speed, determine the value of the heat quantity (the sound speed converted heat quantity Qs).

More specifically, for example, the device may be configured to measure the sound speed of the gas of interest, for example, by the sound speed measurement means, and on the basis of the resulting value of the sound speed, the sound speed to heat quantity converting means is allowed to determine the sound speed converted heat quantity Qs by utilizing the correlation between the sound speed and the heat quantity (for example, the correlation between the sound speed and the heat quantity of a paraffin-based hydrocarbon gas) which has been obtained in advance, for example, by drawing a graph. Or alternatively, the device may also be configured such that the sound speed measurement means measures the sound speed of the gas of interest; on the basis of the resulting value of the sound speed, density computing means computes the value of the density of the gas of interest from Equation (2) below; and further, on the basis of the resulting value of the density, density to heat quantity converting means determines the sound speed converted heat quantity Qs by utilizing the correlation between the density and the heat quantity (for example, the correlation between the density and the heat quantity of a paraffin-based hydrocarbon gas) which has been obtained in advance, for example, by drawing a graph.

Here, in Equation (2) below, γ is the specific heat ratio, R is the gas constant, T is the temperature of the gas of interest, and c is the sound speed of the gas of interest.

Density=γRT/c² Equation (2)

In these devices of (1-1) to (1-3), it is preferable to supply the gas of interest to the measurement means, configured to measure a physical property value having a particular correlation with the heat quantity, through the gas inlet and the gas flow path which are common to the refractive index measurement means 32 and the sound speed measurement means 35, the means 32 and 35 constituting the specific gravity measuring mechanism 30.

As described above, the gas inlet and the gas flow path are provided which are common to both the measurement means constituting the heat quantity measuring mechanism 40 and the measurement means constituting the specific gravity measuring mechanism 30. This provides a higher degree of flexibility to the design of the Wobbe index measuring device 20 itself and makes it possible to supply the gas of interest at the same time to a plurality of measurement means which constitute the Wobbe index measuring device 20.

Among these devices of (1-1) to (1-3), the device (the device of (1-1)) which is configured to determine the refractive index converted heat quantity Qn and the device (the device of (1-3)) which is configured to determine the sound speed converted heat quantity Qs are preferable.

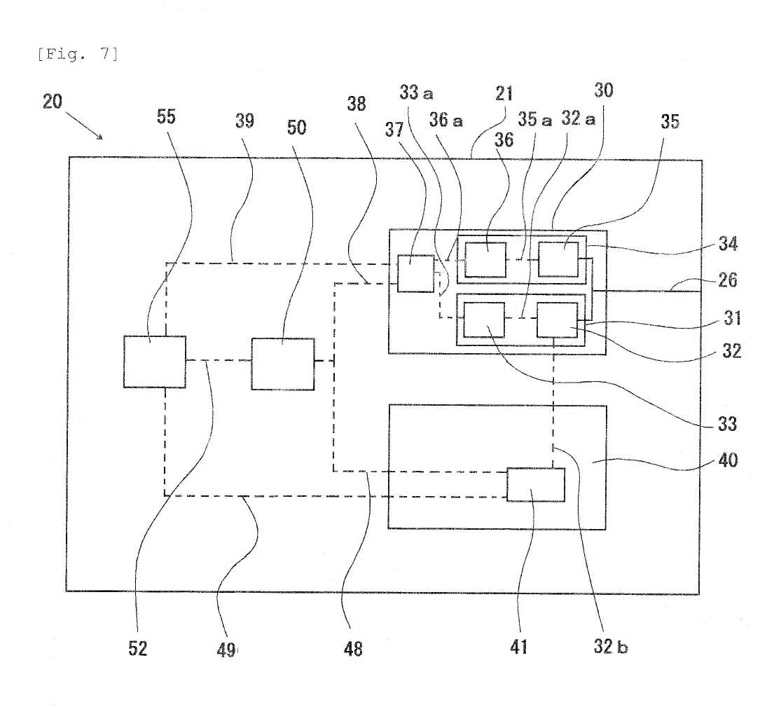

As shown in FIG. 7, when the device which is configured to determine the refractive index converted heat quantity Qn is employed as the heat quantity measuring mechanism 40, the refractive index converted heat quantity Qn can be obtained by utilizing the data of the value of the refractive index measured by the refractive index measurement means 32 constituting the specific gravity measuring mechanism 30. This allows the number of components which constitute the Wobbe index measuring device 20 to be reduced, thereby reducing the device in size.

FIG. 7 shows refractive index to heat quantity converting means 41 for determining the value of the heat quantity on the basis of the data of the value of the refractive index of a gas transmitted through a data transmission path 32b from the refractive index measurement means 32 of the specific gravity measuring mechanism 30.

On the other hand, to employ, as the heat quantity measuring mechanism 40, such an arrangement for determining the sound speed converted heat quantity Qs, the sound speed converted heat quantity Qs can be obtained by utilizing the data of the value of the sound speed measured by the sound speed measurement means 35 which constitutes the specific gravity measuring mechanism 30. This allows the number of components which constitute the Wobbe index measuring device 20 to be reduced, thereby reducing the device in size.

Furthermore, specific examples of the device which is configured to determine the computed heat quantity on the basis of two converted heat quantity values may include the devices of (2-1) and (2-2) below.

(2-1) A device which is configured to determine the heat quantity (the computed heat quantity Qsn) on the basis of the sound speed converted heat quantity Qs and the refractive index converted heat quantity Qn.

More specifically, the device may be configured to allow a heat quantity calculating mechanism to compute the computed heat quantity Qns of a gas of interest from Equation (3) below under the condition of using a value selected as a correction factor α1 from within a range of 1.1 to 4.2, preferably within a range of 2.40 to 2.60. This computation is carried out on the basis of the sound speed converted heat quantity Qs which is obtained by the sound speed to heat quantity converting means according to the value of the sound speed of the gas of interest measured, for example, by the sound speed measurement means and on the basis of the refractive index converted heat quantity Qn which is obtained by the refractive index to heat quantity converting means according to the value of the refractive index of gas of interest measured by the refractive index measurement means.

Qns=Qn−[(Qn−Qs)/(1−α1)] Equation (3)

(2-2) A device which is configured to determine the value of the heat quantity (the computed heat quantity Qtn) on the basis of the thermal conductivity converted heat quantity Qt and the refractive index converted heat quantity Qn.

More specifically, the device may be configured to allow the heat quantity calculating mechanism to compute the computed heat quantity Qnt of the gas of interest from Equation (4) below under the condition of using a value selected as a correction factor α2 from within a range of 1.5 to 4.8, preferably within a range of 2.21 to 2.75. This computation is carried out on the basis of the thermal conductivity converted heat quantity Qt which is obtained by the thermal conductivity to heat quantity converting means according to the value of the thermal conductivity of the gas of interest measured, for example, by the thermal conductivity measurement means and on the basis of the refractive index converted heat quantity Qn which is obtained by the refractive index to heat quantity converting means according to the value of the refractive index of the gas of interest measured by the refractive index measurement means.

Qnt=Qn−[(Qn−Qt)/(1−α2)] Equation (4)

Among these devices of (2-1) and (2-2), the device (the device of (2-1)) which is configured to determine the computed heat quantity Qns is preferable.

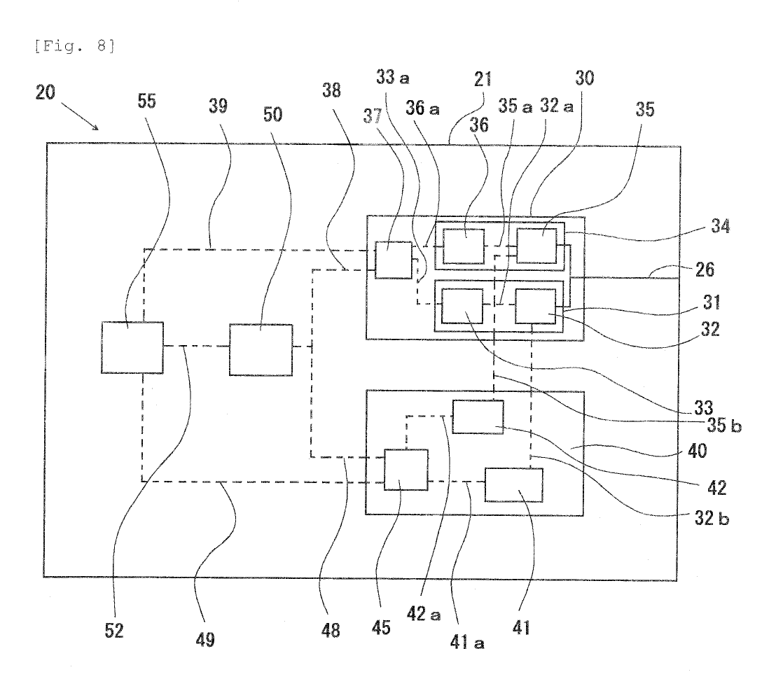

As shown in FIG. 8, when the device configured to determine the computed heat quantity Qns is used as the heat quantity measuring mechanism 30, the refractive index converted heat quantity Qn and the sound speed converted heat quantity Qs can be obtained by utilizing the data of the value of the refractive index and the data of the value of the specific gravity, the pieces of data being measured by the refractive index measurement means 32 and the sound speed measurement means 35 which constitute the specific gravity measuring mechanism 30. This allows the number of components which constitute the Wobbe index measuring device 20 to be reduced, thereby reducing the device in size.

FIG. 8 shows the refractive index to heat quantity converting means 41 for determining the value of the heat quantity on the basis of the data of the value of the refractive index of a gas of interest transmitted through the data transmission path 32b from the refractive index measurement means 32 of the specific gravity measuring mechanism 30. Also shown is sound speed to heat quantity converting means 42 for determining the value of the heat quantity on the basis of the data of the value of the sound speed of the gas of interest transmitted through a data transmission path 35b from the sound speed measurement means 35 of the specific gravity measuring mechanism 30. Further shown is a heat quantity calculating mechanism 45 for computing the computed heat quantity Qns of the gas of interest on the basis of the data of the sound speed converted heat quantity Qs transmitted through a data transmission path 42a from the sound speed to heat quantity converting means 42 and on the basis of the data of the refractive index converted heat quantity Qn transmitted through a data transmission path 41a from the refractive index to heat quantity converting means 41.

(Calculating Mechanism)

The Wobbe index calculating mechanism 50, as used herein, is capable of computing the value of a Wobbe index on the basis of the value of the specific gravity Da obtained in the specific gravity measuring mechanism 30 and the value of the heat quantity Q obtained in the heat quantity measuring mechanism 40.

Here, the Wobbe index is the value that is computed from Equation (5) below.

Wobbe index (WI)=Q/Da^{1/2} Equation (5)

Specifically, it is possible to use as the Wobbe index calculating mechanism 50, for example, a personal computer or a recorder with an arithmetic function.

In the Wobbe index measuring device 20 having such a configuration, the specific gravity measuring mechanism 30 determines the value of the specific gravity Da, while the heat quantity measuring mechanism 40 determines the value of the heat quantity Q. To this end, the gas of interest is drawn into the housing 21 through the gas inlet of the housing 21 and then supplied through the gas flow path 26 to measurement means which measures a physical property value of the gas of interest and which constitutes the specific gravity measuring mechanism 30 (more specifically, the refractive index measurement means 32 and the sound speed measurement means 35). On the other hand, the gas of interest is also supplied, as required, to measurement means which measures a physical property value of the gas of interest and constitutes the heat quantity measuring mechanism 40. Then, the data of the value of the specific gravity Da obtained in the specific gravity measuring mechanism 30 is transmitted to the Wobbe index calculating mechanism 50 through the data transmission path 38, and the data of the value of the heat quantity Q obtained in the heat quantity measuring mechanism 40 is transmitted to the Wobbe index calculating mechanism 50 through the data transmission path 48. This allows the calculating mechanism 50 to compute the value of the Wobbe index from Equation (5) above on the basis of the value of the specific gravity Da and the value of the heat quantity Q. The value of the specific gravity Da, the value of the heat quantity Q, and the value of the Wobbe index WI, which have been obtained in this manner, are each transmitted to the display unit 55 through the data transmission paths 39, 49 and 52, and then displayed on the display unit 55.

The Wobbe index measuring device 20 described above employs, as a gas of interest, a combustible gas which is one type of flammable gas of a hydrocarbon gas, hydrogen gas, and carbon monoxide gas or two or more types of flammable gas of those flammable gases in combination. However, a combustible gas constituting the gas of interest may contain, as another component, at least one type of gas of a carbon dioxide gas, nitrogen gas, and oxygen gas in the form of a mixed gas.

Specific examples of the gas of interest may include, for example, a natural gas, coke oven gas, blast furnace gas, converter gas, coal mine gas, and biogas. These gases contain a mixed gas such as a carbon monoxide gas, carbon dioxide gas, nitrogen gas, and oxygen gas in conjunction with a particular gas such as a paraffin-based hydrocarbon gas and a hydrogen gas.

The Wobbe index measuring device 20 is configured to include the specific gravity measuring mechanism 30, the heat quantity measuring mechanism 40, and the Wobbe index calculating mechanism 50 which are provided in a prescribed manner within the common housing 21. Thus, at the time of measurement, the measurement system can be set up and manipulated in a simplified manner without requiring a considerable length of time, also allowing for performing continual measurements. In addition, the gas of interest can be supplied to each of the refractive index measurement means 32 and the sound speed measurement means 35, which constitute the specific gravity measuring mechanism 30, and the measurement means which is provided in the heat quantity measuring mechanism 40 as required and which measures the physical property value of the gas of interest from the gas inlet provided on the housing 21 through the gas flow path 26. This allows the gas of interest to be supplied to each of the measurement means at the same time. It is thus possible to prevent the occurrence of a time lag between the value of the heat quantity and the value of the specific gravity which are made available for computation of the Wobbe index.

Furthermore, the specific gravity measuring mechanism 30 is configured to compute the value of the specific gravity Da of the gas of interest from a particular arithmetic equation using a value within a particular range as a correction factor x on the basis of the refractive index converted specific gravity Dn obtained in the refractive index converted specific gravity measuring mechanism 31 and the sound speed converted specific gravity Ds obtained in the sound speed converted specific gravity measuring mechanism 34. The gas of interest may contain a mixed gas, which does not have the same properties as those of a particular gas, in conjunction with the particular gas, or may contain only a mixed gas. Even in these cases, the difference occurring between the refractive index converted specific gravity Dn and the true value of the specific gravity of the gas of interest and the difference occurring between the sound speed converted specific gravity Ds and the true value of the specific gravity of the gas of interest, the differences being caused by the mixed gas being contained, are appropriately corrected on the basis of the relation between the differences between these two values and the true values thereof. Thus, the resulting value of the specific gravity Da of the gas of interest used to determine the Wobbe index in the Wobbe index calculating mechanism 50 has a reduced difference from the true value of the specific gravity of the gas of interest irrespective of the composition of the gas of interest, that is, is approximated to the true value of the specific gravity of the gas of interest.

Thus, the Wobbe index measuring device 20 is capable of performing continual measurements with high reliability irrespective of the composition of the gas of interest and obtaining the value of the Wobbe index in a short time.

The Wobbe index measuring device 20 is capable of measuring the specific gravity of a gas of interest with high reliability even when the gas of interest is a gas which contains a particular gas and a mixed gas at an unknown ratio, or more specifically, a natural gas which has been just produced from a gas field, coke oven gas, blast furnace gas, converter gas, coal mine gas, and biogas.

Furthermore, the Wobbe index measuring device 20 is capable of measuring the specific gravity of the gas of interest with high reliability even when the gas of interest is composed only of a particular gas (more specifically, a paraffin-based hydrocarbon gas) such as a town gas which contains a gas mixture of, for example, an LNG and an LPG or even when the gas of interest is composed only of a mixed gas (for example, composed of a gas mixture of a carbon monoxide gas and another mixed gas.)

Furthermore, according to the Wobbe index measuring device 20, the resulting value of the Wobbe index has a reduced difference from the true value of the Wobbe index of the gas of interest irrespective of the composition of the gas of interest. Thus, for example, even when environment conditions or various situations such as changes of supplied gases flowing through the gas pipeline 12 have caused significant variations in the type and concentration of a mixed gas in the gas of interest, these variations can be accommodated.

In the foregoing, the present invention have been described in detail, more specifically, in accordance with the method for measuring the specific gravity of a combustible gas according to the present invention; the device for measuring the specific gravity of a combustible gas according to the present invention, and the device for measuring the Wobbe index of a combustible gas according to the present invention. However, the present invention is not limited to the examples described above, but may be modified in a variety of ways.

For example, the method for measuring the specific gravity of a combustible gas is not limited to being performed by a device which includes, in combination, the refractive index converted specific gravity measuring mechanism, the sound speed converted specific gravity measuring mechanism, and the specific gravity calculating mechanism. As long as the value of the specific gravity Da of the gas of interest is computed from Equation (1) above on the basis of the refractive index converted specific gravity Dn and the sound speed converted specific gravity Ds under the condition of using a value selected as a correction factor x from within a range of 2.4 to 9.3, the devices for obtaining the refractive index converted specific gravity Dn and the sound speed converted specific gravity Ds may not have to be integrated but separated. In addition, the technique for computing the value of the specific gravity Da of the gas of interest may be automatically performed by a computing machine or manually performed.

Furthermore, in the device for measuring the Wobbe index of a combustible gas, as long as the specific gravity measuring mechanism, the heat quantity measuring mechanism, and the Wobbe index calculating mechanism are provided in a prescribed manner within the common housing, each of these mechanisms may be removably provided. In such a case, each mechanism can be maintained with ease.

Furthermore, the device for measuring the Wobbe index of a combustible gas may be configured such that the housing is provided with a plurality of gas inlets, that the gas of interest is supplied individually to each of the measurement means which constitute the specific gravity measuring mechanism and the heat quantity measuring mechanism and which measure a physical property value of the gas of interest.

Now, a description will be made to Experimental Examples of the present invention.

### Experimental Example 1

With a nitrogen gas, oxygen gas, carbon dioxide gas, and carbon monoxide gas employed as a sample gas, each of these sample gases is measured with a refractive index type densimeter and a sound speed type densimeter so as to compute the ratio (refractometer error value/sound speed meter error value) (hereafter also referred to as the “error ratio”) of the difference (hereafter also referred to as the “refractometer error value”) between the value measured by the refractive index type densimeter and the true value of the specific gravity of a sample gas to the difference (hereafter also referred to as “the sound speed meter error value”) between the value measured by the sound speed type densimeter and the true value of the specific gravity of the sample gas. The results are shown in Table 1 below.

Here, the “refractometer error value” and the “sound speed error value” are each indicative of the difference which may occur between the measured values and the true value of the specific gravity of a gas mixture per one volume % of a sample gas when the sample gas is contained in a paraffin-based hydrocarbon gas. The measured values are obtained when the specific gravities of the gas mixture of the sample gas and the paraffin-based hydrocarbon gas are measured each using the refractive index type densimeter and the sound speed type densimeter.

TABLE 1

| | REFRAC- | SOUND | |
|---|---|---|---|
| | TOMETER | SPEED | |
| | ERROR | METER | ERROR |
| SAMPLE GAS | VALUE | ERROR VALUE | RATIO |
| NITROGEN GAS | −0.00640 | −0.00113 | 5.66 |
| OXYGEN GAS | −0.00822 | −0.00146 | 5.63 |
| CARBON DIOXIDE GAS | −0.00964 | −0.00156 | 6.18 |
| CARBON MONOXIDE GAS | −0.00581 | −0.00118 | 4.92 |

The results in Table 1 above clearly show that any one of the sample gases, i.e., the nitrogen gas, oxygen gas, carbon dioxide gas, and carbon monoxide gas, has the refractometer error value that is greater than the sound speed meter error value. Also shown is that the ratio (error ratio) of the refractometer error value to the sound speed meter error value takes on a numerical value within a narrow range irrespective of the type of the sample gas, that is, takes on an approximated value irrespective of the composition of the sample gas.

### Experimental Example 2

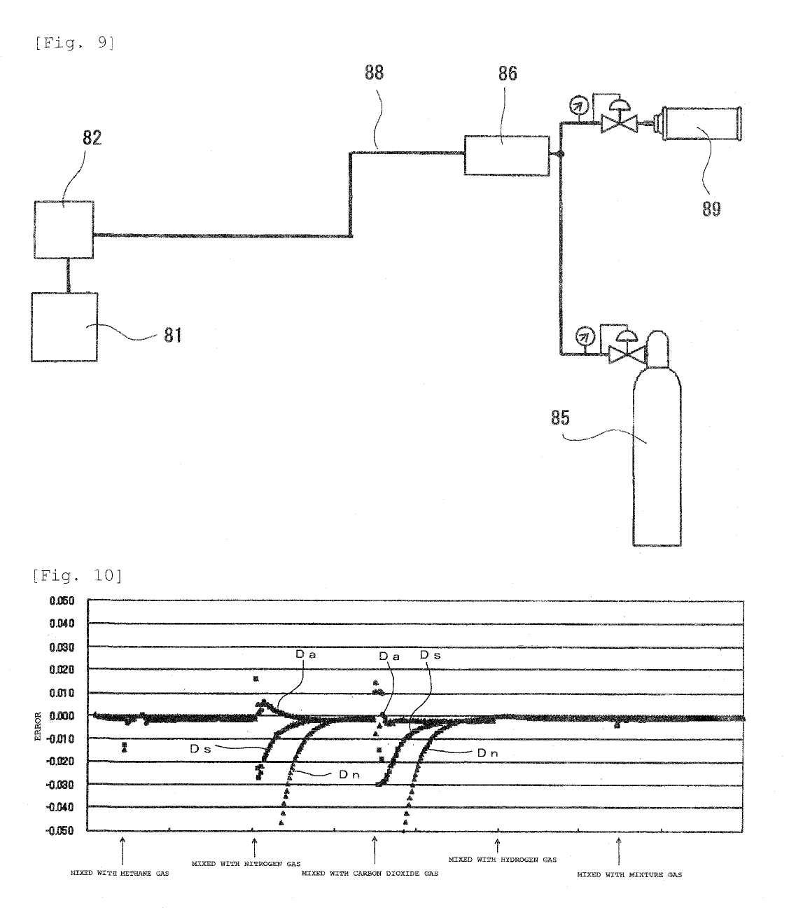

Prepared was a specific gravity measurement system, as shown in FIG. 9, which has the refractive index type densimeter 81 and the sound speed type densimeter 82 connected in series to each other via a sample gas supply path 88, and which is configured to supply a sample gas to each of the refractive index type densimeter 81 and the sound speed type densimeter 82 so as to measure the specific gravity. Using the specific gravity measurement system, five types of gases were employed as sample gases which were prepared by mixing the natural gas of a specific gravity of 0.635 supplied via a buffer tank 86 of a volume of 2 liters from a cylinder 85 with any one type of a methane gas, nitrogen gas, carbon dioxide gas, hydrogen gas, and a gas mixture of methane gas and ethane gas. Then, the refractive index converted specific gravity Dn and the sound speed converted specific gravity Ds of each of those sample gases were measured with the refractive index type densimeter 81 and the sound speed type densimeter 82. Subsequently, the true value of the specific gravity of each sample gas was computed from the refractive index converted specific gravity Dn measured by the refractive index type densimeter 81, and the differences between the resulting true value of the specific gravity and the refractive index converted specific gravity Dn and the sound speed converted specific gravity Ds were checked. The results are shown in FIG. 10.

Here, the methane gas, the nitrogen gas, the carbon dioxide gas, the hydrogen gas, and the gas mixture of the methane gas and the ethane gas were mixed in that order and then each of the sample gases was measured with the refractive index type densimeter 81 and the sound speed type densimeter 82. Furthermore, the measurements of each sample gas were carried out for a length of time after the methane gas, the nitrogen gas, the carbon dioxide gas, the hydrogen gas, and the gas mixture of the methane gas and the ethane gas are each charged into the buffer tank 86 from respective gas cans 89 until the buffer tank 86 is again replaced with the natural gas.

In FIG. 10, the value of the difference between the refractive index converted specific gravity in obtained in the refractive index type densimeter 81 and the true value of the specific gravity of the sample gas was denoted by a solid triangular plot (▴), while the value of the difference between the sound speed converted specific gravity is obtained in the sound speed type densimeter 82 and the true value of the specific gravity of the sample gas was denoted by a solid square plot (▪). Note that in FIG. 10, the curved group of triangular plots indicative of the value of the difference between the refractive index converted specific gravity Dn and the true value of the specific gravity of the sample gas is denoted by symbol “Dn,” while the curved group of square plots indicative of the value of the difference between the sound speed converted specific gravity Ds and the true value of the specific gravity of the sample gas is denoted by symbol “Ds.”

The results of FIG. 10 discussed above show that when the methane gas, the hydrogen gas, and the gas mixture of the methane gas and the ethane gas are mixed, any of the refractive index converted specific gravity Dn and the sound speed converted specific gravity Ds has almost no difference from the true value of the specific gravity of the sample gas. It is also shown that when the nitrogen gas and the carbon dioxide gas are mixed, both the refractive index converted specific gravity Dn and the sound speed converted specific gravity Ds have a big difference from the true value of the specific gravity of the sample gas.

Furthermore, the value of the specific gravity Da of each sample gas was computed from Equation (1) above under the condition of the correction factor x being 6.00 on the basis of the refractive index converted specific gravity Dn provided by the refractive index type densimeter 81 and the sound speed converted specific gravity Ds provided by the sound speed type densimeter 82. Then, the difference between the value of the specific gravity Da and the true value of the specific gravity of the sample gas was checked. This check shows that the value of the specific gravity Da has a reduced difference from the true value of the specific gravity of the sample gas when compared with any of the refractive index converted specific gravity Dn and the sound speed converted specific gravity Ds. These results are shown together in FIG. 10.

In FIG. 10, the value of the difference between the value of the specific gravity Da and the true value of the specific gravity of the sample gas is denoted by a solid circular plot (). Note that in FIG. 10, the curved group of circular plots indicative of the value of the difference between the value of the specific gravity Da and the true value of the specific gravity of the sample gas is denoted by symbol “Da”.

From the results of Experimental Example 2, it has been confirmed that the value of the specific gravity Da can be computed by Equation (1) above using a value within a particular range as the correction factor x on the basis of the refractive index converted specific gravity Dn and the sound speed converted specific gravity Ds of the gas of interest, thereby enabling the specific gravity of the gas of interest to be measured with high reliability irrespective of the composition of the mixed gas and the composition of the gas of interest.

### REFERENCE SIGNS LIST

10 specific gravity measuring device
12 gas pipeline
16 gas flow path
18 display unit
19 data transmission path
20 Wobbe index measuring device
21 housing
26 gas flow path
30 specific gravity measuring mechanism
31 refractive index converted specific gravity measuring mechanism
32 refractive index measurement means
32a, 32b data transmission path
33 refractive index to specific gravity converting means
33a data transmission path
34 sound speed converted specific gravity measuring mechanism
35 sound speed measurement means
35a, 35b data transmission path
36 sound speed to specific gravity converting means
36a data transmission path
37 specific gravity calculating mechanism
38, 39 data transmission path
40 heat quantity measuring mechanism
41 refractive index to heat quantity converting means
41a data transmission path
42 sound speed to heat quantity converting means
42a data transmission path
45 heat quantity calculating mechanism
48, 49 data transmission path
50 Wobbe index calculating mechanism
52 data transmission path
55 display unit
61 measurement pipe
61A gas inlet
61B gas outlet
62A ultrasound emitter element
62B ultrasound receiver element
65 measurement pipe
65A gas inlet
65B gas outlet
66 piezoelectric element
71 chamber
72 gas-of-interest cell
73A, 73B standard-gas cell
74 light source
75 parallel plane mirror
76 interference fringe detection means
77 plane mirror
78 prism
79 condenser lens
81 refractive index type densimeter
82 sound speed type densimeter
85 cylinder
86 buffer tank
88 sample gas supply path
89 gas can

1. A method for measuring a specific gravity of a combustible gas which contains at least one type of gas selected from a hydrocarbon gas, hydrogen gas, and carbon monoxide gas, the method comprising:
measuring a refractive index of a gas of interest;
measuring a sound speed of the gas of interest; and
computing a value of a specific gravity Da of the gas of interest from Equation (1) below using a value selected as a correction factor x from within a range of 2.4 to 9.3 on the basis of a refractive index converted specific gravity Dn determined from the value of the refractive index and a sound speed converted specific gravity Ds determined from the value of the sound speed,
Da=Ds−[(Ds−Dn)/(1−x)] Equation (1).

2. The method for measuring a specific gravity of a combustible gas according to claim 1, wherein the value of the correction factor x is 4.9 to 6.2 in said Equation (1).

3. The method for measuring a specific gravity of a combustible gas according to claim 1, wherein the gas of interest contains at least one type of a carbon dioxide gas, nitrogen gas, and oxygen gas.

4. The method for measuring a specific gravity of a combustible gas according to claim 1, wherein the gas of interest is any of a natural gas, coke oven gas, blast furnace gas, converter gas, coal mine gas, and biogas.

5. A device for measuring a specific gravity of a combustible gas which contains at least one type of gas selected from a hydrocarbon gas, hydrogen gas, and carbon monoxide gas, the device comprising:
a refractive index converted specific gravity measuring mechanism for determining a refractive index converted specific gravity Dn from a value of a refractive index of a gas of interest;
a sound speed converted specific gravity measuring mechanism for determining a sound speed converted specific gravity Ds from a value of a sound speed of the gas of interest; and
a specific gravity calculating mechanism for computing a value of a specific gravity Da of the gas of interest from Equation (1) below using a value selected as a correction factor x from within a range of 2.4 to 9.3 on the basis of the refractive index converted specific gravity Dn obtained in the refractive index converted specific gravity measuring mechanism and the sound speed converted specific gravity Ds obtained in the sound speed converted specific gravity measuring mechanism,
Da=Ds−[(Ds−Dn)/(1−x)] Equation (1).

6. A device for measuring a Wobbe index of a combustible gas which contains at least one type of gas selected from a hydrocarbon gas, hydrogen gas, and carbon monoxide gas, the device comprising:
a specific gravity measuring mechanism for measuring a specific gravity of a gas of interest;
a heat quantity measuring mechanism for measuring a heat quantity of the gas of interest; and
a Wobbe index calculating mechanism for computing a value of a Wobbe index on the basis of the value of the specific gravity measured by the specific gravity measuring mechanism and the value of the heat quantity measured by the heat quantity measuring mechanism, the mechanisms being installed within a common housing,
wherein the specific gravity measuring mechanism computes a value of a specific gravity Da of the gas of interest on the basis of a refractive index converted specific gravity Dn determined from the value of the refractive index of the gas of interest and a sound speed converted specific gravity Ds determined from a value of a sound speed of the gas of interest from Equation (1) below using a value selected as a correction factor x from within a range of 2.4 to 9.3,
Da=Ds−[(Ds−Dn)/(1−x)] Equation (1).

7. The device for measuring a Wobbe index of a combustible gas according to claim 6, wherein the value of the correction factor x is 4.9 to 6.2 in said Equation (1).

8. The device for measuring a Wobbe index of a combustible gas according to claim 6, wherein:
the specific gravity measuring mechanism includes refractive index measurement means for measuring the refractive index of the gas of interest and sound speed measurement means for measuring the sound speed of the gas of interest, and
the refractive index measurement means and the sound speed measurement means are supplied with the gas of interest drawn in through a common gas inlet provided in the housing.

9. The device for measuring a Wobbe index of a combustible gas according to claim 6, wherein the gas of interest contains at least one type of a carbon dioxide gas, nitrogen gas, and oxygen gas.

10. The device for measuring a Wobbe index of a combustible gas according to claim 6, wherein the gas of interest is any of a natural gas, coke oven gas, blast furnace gas, converter gas, coal mine gas, and biogas.

11. The method for measuring a specific gravity of a combustible gas according to claim 2, wherein the gas of interest contains at least one type of a carbon dioxide gas, nitrogen gas, and oxygen gas.

12. The method for measuring a specific gravity of a combustible gas according to claim 2, wherein the gas of interest is any of a natural gas, coke oven gas, blast furnace gas, converter gas, coal mine gas, and biogas.

13. The device for measuring a Wobbe index of a combustible gas according to claim 7, wherein:
the specific gravity measuring mechanism includes refractive index measurement means for measuring the refractive index of the gas of interest and sound speed measurement means for measuring the sound speed of the gas of interest, and
the refractive index measurement means and the sound speed measurement means are supplied with the gas of interest drawn in through a common gas inlet provided in the housing.

14. The device for measuring a Wobbe index of a combustible gas according to claim 7, wherein the gas of interest contains at least one type of a carbon dioxide gas, nitrogen gas, and oxygen gas.

15. The device for measuring a Wobbe index of a combustible gas according to claim 7, wherein the gas of interest is any of a natural gas, coke oven gas, blast furnace gas, converter gas, coal mine gas, and biogas.
